(19) United States
(12) Patent Application Publication
(10) Pub. No.: US 2016/0036766 A1
(43) Pub. Date: Feb. 4, 2016

(54) METHOD AND SYSTEM FOR SYNCHRONIZING PROGRAM MASKS

(71) Applicant: Himmelsbach Computer Gmbh, Seelbach (DE)

(72) Inventor: Markus HIMMELSBACH, Seelbach (DE)

(21) Appl. No.: 14/883,818

(22) Filed: Oct. 15, 2015

Related U.S. Application Data
(63) Continuation of application No. PCT/EP2013/057791, filed on Apr. 15, 2013.

(51) Int. Cl. H04L 29/12; H04L 29/08; H04L 29/06

(52) U.S. Cl. CPC H04L 61/1582; H04L 67/42; H04L 67/34

(57) ABSTRACT

A method is provided for synchronization of program masks, wherein the method comprises receiving a first request message from the first client means, wherein a first program mask is requested by the first request message, determining a first unique identifier for the requested first program mask, transmitting the requested first program mask and the first unique identifier to the first client means, receiving a second request message from the second client means, wherein the second request message comprises at least the first unique identifier, determining the first program mask, which is assigned to the received first unique identifier, and transmitting the determined first program mask to the second client means.

### CROSS REFERENCE TO RELATED APPLICATIONS

This application is a continuation of International Application No. PCT/EP2013/057791, filed Apr. 15, 2013, the contents of which are incorporated by reference herein.

### TECHNICAL FIELD

The invention relates to a method for synchronization of program masks in a system having at least one server means and at least one first client means and a second client means, wherein the client means can be coupled to the server means, and wherein the synchronization of the program masks can be carried out off-line as well as online. Further, the invention relates to a system, in particular, a data processing means being adapted to carry out the method for synchronization of program masks according to the invention.

### BACKGROUND

Computer programs, websites, or other software products are becoming more and more complex and comprehensive due to technical developments. The more complex and comprehensive the computer programs or websites are becoming, the more difficult it will be to arrive in an efficient manner at a defined location (for example, an input mask of a computer program on a specific Internet page of a website) of the computer program or of the website, for example, for purposes of support. This is, for example, necessary in the context of a support process, in order to enable two or more persons (for example, a support assistant and a customer) being spatially separated from each other to talk to each other or to exchange views with respect to the same display content (input mask of a computer program or Internet page of a website). Here, there exists a problem in that it has to be ensured that the support assistant as well as the customer both are viewing the same input mask or Internet page.

A further problem, in particular, within the context of a support process, is that the input mask or website displayed at the customer's site may not be adapted or modified by the support assistant in order to notify the customer, for example, on information in the input mask or website being relevant for him, or to adapt or modify certain information within the input mask or website for the customer without such a modification having any influence on the display of the same input mask or website at other customer's sites. For example, the price of a product being displayed on a website for a certain customer viewing the website may not be adapted, for example, may not be reduced.

It is known from prior art to enable access to the remote system of the customer by a support assistant, for example, by means of a remote control software. This solution, however, has several disadvantages.

At first, it is necessary for the client software to be installed on the system of the client such that the support assistant is enabled to access the system of the customer. Legal restrictions, as corporate principles, however, may prevent the customer from being allowed to install such a client software on his system.

Even if the customer has installed such a client software, technical restrictions may lead to the support assistant not being allowed to access the system of the customer, for example, if a firewall of the company prevents a remote access. The implementation of such remote control software, thereby, is very time-consuming and prone to errors. In particular, in case support is only needed rarely, the implementation of such remote control software may pose a substantial expense factor, which renders such an implementation uneconomical.

Therefore, it is an object of the invention to provide solutions, by means of which it may be ensured in a simple, efficient, and substantially error-free manner that two or more persons being spatially separated from each other are viewing the same program mask of a computer program or the same internet page of a website, without additional software having to be installed for this on a remote computer, and which enable to adapt or to modify the displayed input mask of a computer program or the displayed internet page of a website for a certain user without the modifications being visible for other users of the computer program or the internet page.

### SUMMARY

According to the invention, this object is solved by a method for synchronization of program masks, a data processing means, as well as a computer program product according to the independent claims. Preferred embodiments of the invention are defined in the dependent claims.

Accordingly, a method for synchronization of program masks in a system is provided, comprising at least a server means and at least a first client means and a second client means, wherein the client means can be coupled to at least a server means, and wherein the method comprises the following steps:
a. receiving a first request message from the first client means, wherein a first program mask is requested by means of the first request message;
b. determining a first unique identifier for the requested first program mask;
c. transmitting the requested first program mask and the first unique identifier to the first client means;
d. receiving a second request message from the first client means, wherein the second request message comprises at least the first unique identifier;
e. determining the first program mask, which is assigned to the received first unique identifier; and
f. transmitting the determined first program mask to the second client means.

Preferably, the determining of the first unique identifier comprises:
a. generating the first unique identifier for the requested first program mask; and
b. storing the first unique identifier in a storage means, wherein the first unique identifier is assigned to the requested first program mask.

It is preferred, if, during determining of the first program mask, the first program mask assigned to the received first unique identifier in the storage means is queried in the storage means and information on the first program mask is received by the storage means as result of the request.

The first unique identifier received with the second request message from the second client means may have been transmitted from the first client means to the second client means.

Also, a method for synchronization of program masks in a system is provided, comprising at least a server means and at least a first client means and a second client means, wherein the client means can be coupled to at least a server means, and wherein the method comprises the following steps:
a. receiving a third request message from the second client means, wherein a second program mask is requested by means of the third request message;
b. determining a second unique identifier for the requested second program mask;
c. transmitting the requested second program mask and the second unique identifier to the second client means;
d. receiving a fourth request message from the first client means, wherein the fourth request message comprises at least the second unique identifier;
e. determining the second program mask, which is assigned to the received second unique identifier; and
f. transmitting the determined second program mask to the first client means.

The determination of the second unique identifier may comprise:
a. generating the second unique identifier for the requested second program mask; and
b. storing the second unique identifier in a storage means, wherein the second unique identifier is assigned to the requested second program mask.

It is preferred, if, during determining of the second program mask, the second program mask assigned to the received second unique identifier in the storage means is queried in the storage means, and information on the second program mask may be received by the storage means as a result of the request.

The second unique identifier received with the fourth request message by the first client means may have been transmitted from the second client means to the first client means.

Further, the steps of the method mentioned at last may be carried out in the method mentioned at first.

In the methods according to the invention, the steps may be carried out on the server side.

In the methods according to the invention, the server means may receive from the second client means an update message comprising information on which parts of the first or second program masks transmitted to the first client means, which comprise a number of parts, are to be updated and how they are to be updated.

In the method according to the invention, the server means may store the received update message in the storage means, and may assign it to the first or second unique identifier.

It is preferable, if the server means provides the update message for transmission to the first client means, in order to prompt an update of the transmitted first or second program masks according to the information comprised in the update message at the first client means.

The server means may prompt, during completion of the method, a deletion of the first or second unique identifiers stored in the storage means.

In a first step, a session may be started for the first client means, and in a last step, the session may be terminated.

Preferably, the first client means may be identified by a unique client identifier, wherein the first and/or the second unique identifier may be assigned to the client identifier, and the assignments are stored in the storage means.

In a last step, the session may be terminated, and the unique identifiers assigned to the client identifier may be deleted in the storage means.

It has been found to be advantageous, if the unique client identifier comprises one of an IP address, MAC address, browser identifier, software license number, hardware serial number, email address, telephone number, EAN code, and a unique biometric feature. The telephone number may be provided with or without an area code.

The first and/or the second program masks may be represented by a hierarchical tree structure, wherein each part of the program mask is represented by a node in the tree structure, wherein each part of the program mask may comprise a number of parts of the program mask, and wherein the update message comprises information on which nodes of the tree structure are to be updated and how they are to be updated.

The first and/or the second program mask may comprise a display field for display of the first or of the second unique identifier, and an input field for input of the first or of the second unique identifier.

The program mask may be an input mask of a computer program or an Internet page.

It is especially preferred, if the first and the second unique identifiers respectively are a numerical sequence, wherein the number of digits of the first identifier is different from the number of digits of the second identifier.

It is specifically advantageous, if the second identifier comprises less digits than the first identifier.

The server means may be a component of the first client means and/or of the second client means, in particular, as a service executable on the first client means and/or on the second client means.

Further, a data processing means is provided, which may be coupled to at least a first client means and a second client means, wherein the data processing means is adapted to execute the method according to the invention.

Further, a computer program product is provided, which may be loaded into the memory of a data processing means, and which comprises program sections, by means of which the steps of the method according to the invention are executed, when the computer program product is being executed on the data processing means.

Further, also a signal sequence is provided, in particular, a computer readable signal sequence, and which is suitable for the transmission in a communications network, wherein the signal sequence represents data, by means of which, if loaded into a processor of a computer, in particular, a data processing means according to the invention, a method according to the invention can be executed.

### BRIEF DESCRIPTION OF THE DRAWINGS

Details and features of the invention as well as concrete embodiments of the invention can be derived from the following description in connection with the drawing, in which:

FIG. 1 shows a section of a website:

FIG. 2a shows a block diagram of a system according to the invention for explaining the method according to the invention in an online mode;

FIG. 2b shows an alternative block diagram of a system according to the invention for explaining the method according to the invention in an off-line mode;

FIG. 3 shows a sequence diagram of a method according to the invention;

FIG. 4 shows a sequence diagram of a method according to the invention;

FIG. 5 shows a flow chart of a method according to the invention, in which the methods according to FIG. 3 and FIG. 4 are combined; and

FIG. 6 shows an example of a program mask, which is adapted or modified according to the method according to the invention.

### DETAILED DESCRIPTION

In the following, the invention will be described by means of an example of an Internet page (also referred to as web page), which is requested by a customer at a client means, and for which the customer is provided with support by a support assistant of the provider of the website. The invention, however, is not restricted to Internet pages. Also, program masks of computer programs (e.g., operating systems, application programs, or so-called APPs), which are executed locally on a computer, a smart phone, a tablet PC or the like can be synchronized.

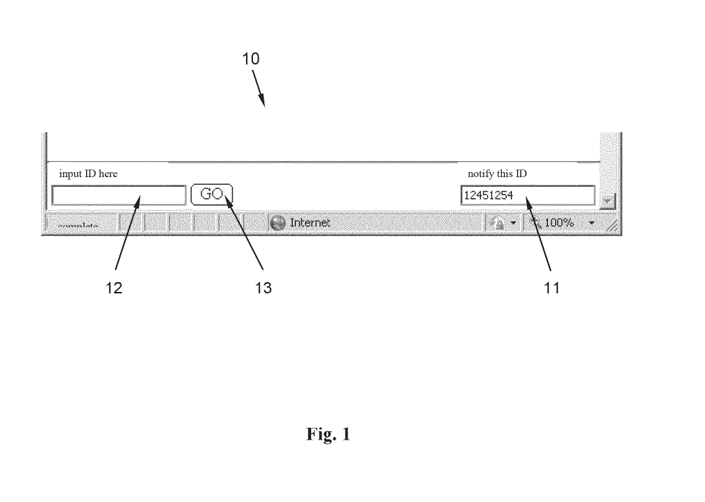

FIG. 1 shows a program mask 10, for example, an Internet page of a website, which is displayed on the customer's site at his client means, for example, a computer, a tablet PC, or a smart phone. The Internet page 10 may be, for example, a product page, on which information on a certain product, the availability of the product, a product price, delivery time, etc. are displayed.

In the lower region or in the bottom region of the Internet page 10, a display field 11, an input field 12, and a button 13 assigned to the input field are displayed. In the display field 11, a unique identifier of the program mask or Internet page 10 is displayed, which, upon requesting the Internet page 10, is generated dynamically by a Web server. In the input field 12, the customer may input a further unique identifier, which is, for example, notified by a support assistant to the customer. The unique identifier to be input into the input field 12, also identifies an Internet page of the website, and is also generated dynamically by the Web server. By manipulating the button 13, the customer may confirm the unique identifier input into the input field 12, and may request the program mask or Internet page assigned to the confirmed unique identifier from the Web server.

The unique identifier input by the customer into the input field 12 is notified to the customer by the support assistant, who has initiated the generation of the unique identifier for the corresponding Internet page. This may, for example, be effected by calling the corresponding Internet page by the support assistant, wherein the dynamically generated unique identifier is notified to the support assistant, who may in turn notify it to the customer.

After the customer has input the unique identifier received from the support assistant into the input field 12, and has manipulated the input by means of the button 13, the same Internet page 10 is displayed at the customer's site and also at the support assistant's site, whereby the Internet pages displayed at the customer's site and at the support assistant's site are synchronized.

The synchronization of the web pages displayed at the customer and at the support assistant may also be effected in opposite direction. For this, the customer informs the support assistant on the unique identifier displayed in the display field 11, who then calls the Internet page assigned to the unique identifier accordingly, whereby the web pages displayed at the customer's site and at the support assistant's site are synchronized.

Preferably, the unique identifiers respectively consist of a numerical sequence. The two numerical sequences may have different lengths.

According to a preferred embodiment of the invention, the numerical sequence to be input into the input field 12 is shorter than the numerical sequence displayed in the display field 11. This has the advantage that the transmission of the unique identifier to be input into the input field 12 is less prone to errors and may be input faster.

The numerical sequence to be input into the input field 12 may also be longer than the numerical sequence displayed in the display field 11.

The use of numerical sequences, moreover, has the advantage that the identification of Internet pages is independent of languages, enabling or substantially facilitating a worldwide implementation of the method according to the invention.

The area, in which the display field 11, the input field 12, and the button 13 are displayed preferably is configured such that it always remains visible, preferably in the bottom region, independently of the scroll position of the Internet page.

The method described above, when using a display field 11 and an input field 12, is specifically advantageous, if the customer visits a website, which does not require an authentication (for example, by means of a login), because without corresponding login, the support assistant lacks information on which Internet page 10 the customer currently has requested.

For websites requiring authentication of the customer, the display field 11, the input field 12 and the button 13 may be omitted. In this case, the support assistant may have a unique identifier generated on the Web server for an Internet page for the logged in customer, which is to be displayed on the client means of the customer, and may store the generated unique identifier, for example, in a database, wherein the generated unique identifier in the database is assigned to the logged in customer. The Internet page displayed at the customer's site may be adapted to query the Web server cyclically in order to determine, whether such a unique identifier is deposited. As far as this is the case, the Internet page may request the Internet page assigned to this identifier by using the deposited unique identifier, similar to the procedure when inputting into the input field 12 a unique identifier, which is confirmed by the button 13. A manual input of a unique identifier into the input field 12 by the customer thereby may be omitted completely, leading to a substantial increase in security, because neither identifiers have to be exchanged outside of the system, nor identifiers have to be input into the input field 12.

In case for synchronization of the program masks, the display field 11 and the input field 12 are used, because, for example, the customer is not logged in, it would, however, also be possible to input into the input fields 12 also an Internet address (URL) instead of unique numerical identifiers, and to request the Internet page identified by this URL by means of manipulating the button 13. This, however, has the substantial disadvantage that an Internet page 10 displayed at the customer's site may no longer be modified or adapted exactly for this customer without other customers also querying the same Internet page having the modifications displayed, too. If, for example, two different customers call one and the same Internet page, it may not be distinguished for which one of the two customers the modifications made to this Internet page are valid.

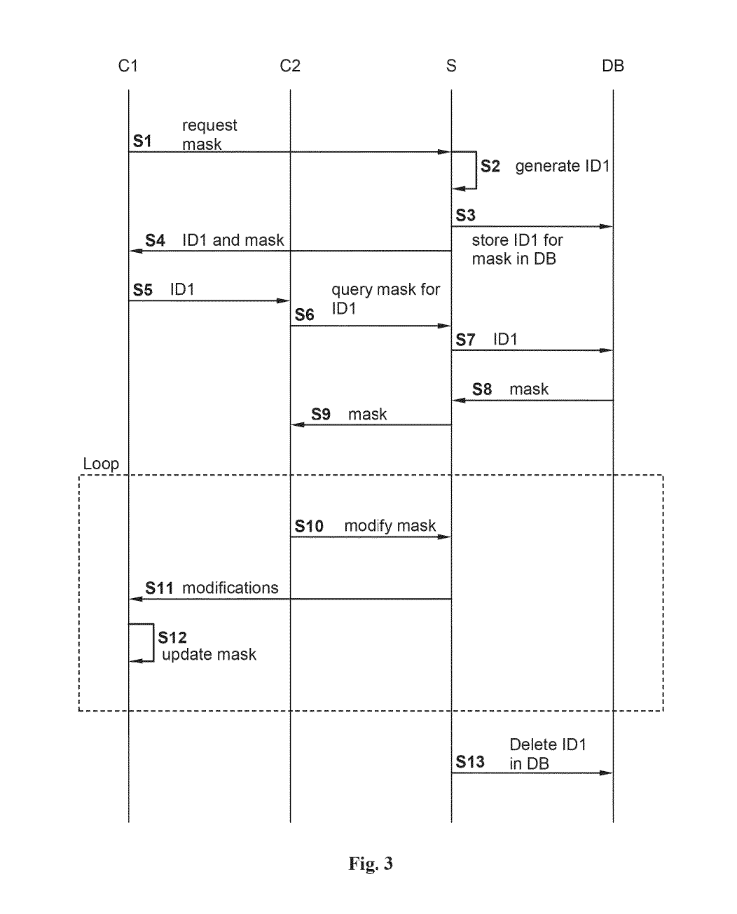

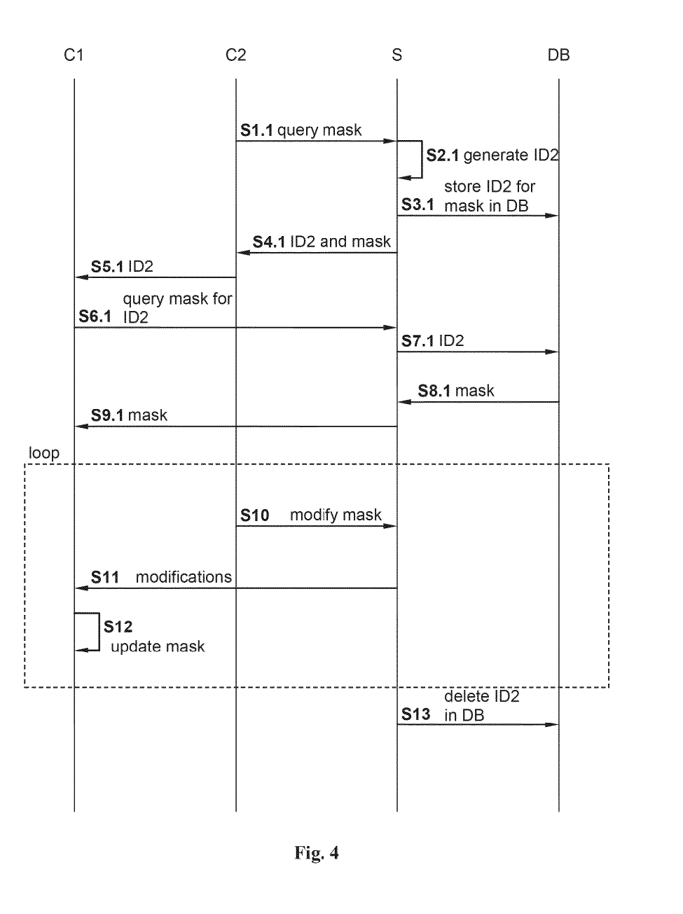

This problem is avoided by using unique identifiers in that for one and the same Internet page being queried by different customers, different identifiers are generated respectively. Thereby, a modification of the Internet page may be carried out for a certain customer without other customers querying the same Internet page learning about this modification. The modification of an Internet page is assigned to the unique identifier of the Internet page according to the invention, as will be described in further detail with reference to FIG. 3 and FIG. 4.

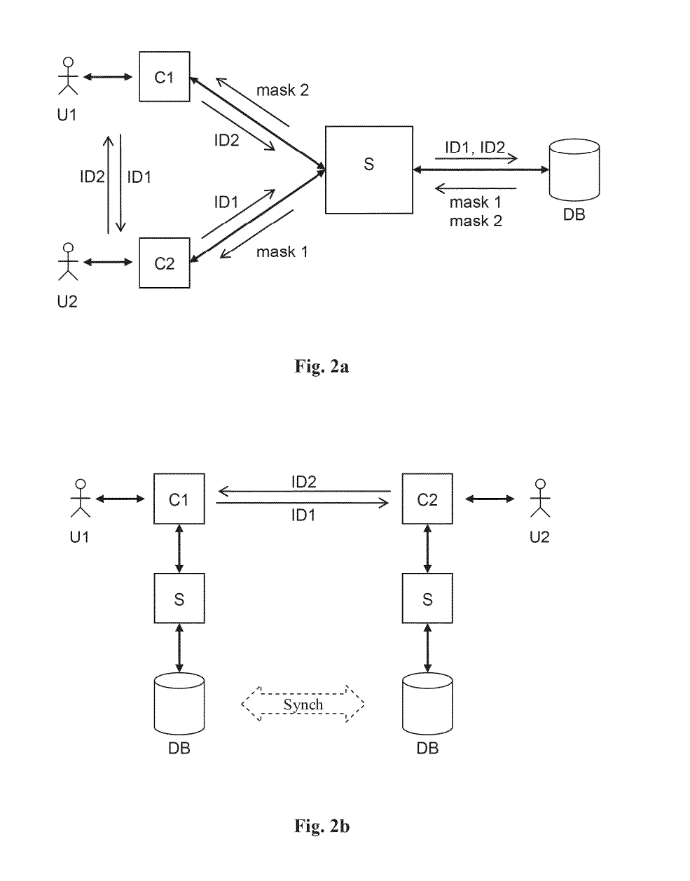

FIG. 2a shows a block diagram of a system according to the invention for explaining the method for synchronization of program masks according to the invention in an online mode.

The first client means C1 and second client means C2 are coupled (online mode) to a server means S via a communications network, for example, the Internet, wherein the server means may be a Web server. The server means is coupled to a database DB. The first client means C1 is assigned to a user U1, who may be, for example, a customer. The second client means C2 is assigned to a second user U2, who may be, for example, a support assistant. On the server means S, a website is hosted, the Internet pages of which may be queried by either one of the first client means C1 and also the second client means C2.

The first user U1 requests, via the first client means C1, an Internet page from the server means S, which is displayed at the first client means C1, and which comprises the display field 11 shown in FIG. 1. During requesting the Internet page via the client means C1, the first unique identifier ID1 is generated by the server means S, and is stored in the database DB, wherein in the database, the unique identifier ID1 is assigned to the requested Internet page. The requested first unique identifier ID1 is transmitted to the first client means C1 together with the requested Internet page, and is displayed there in the display field 11.

The first user U1 may now inform the second user U2 about the first unique identifier ID1. The second user U2 may input the first unique identifier ID1 notified to him into a support input field at the second client means C2, and may request the Internet page assigned to this unique identifier from the Web server S. For this, the first unique identifier ID1 is transmitted from the second client means C2 to the server means S, which queries the Internet page belonging to this unique identifier from the database DB by means of the first unique identifier ID1. The Internet page (mask 1) thus determined is then transmitted from the server means S to the second client means C2 and is displayed there. The Internet pages displayed at the first client means C1 and at the second client means C2 are now synchronous, i.e., the same Internet page is displayed to the users U1 and U2. As a result, the first user U1 and the second user U2 are able to communicate via the displayed Internet page.

If both users U1, U2 find out that, for example, the product advertised on the displayed Internet page does not comprise the desired features, the second user U2 or the support assistant may “guide” the first user U1 or the customer to another Internet page, on which an alternative product is advertised. For this, the second user U2 requests an alternative Internet page via the second client means C2 from the server means S. For the requested alternative Internet page, the server means S generates a second unique identifier ID2, and stores the second unique identifier ID2 in the database DB. The second unique identifier ID2 is assigned to the requested alternative Internet page in the database. As reaction to the request of the alternative Internet page, the alternative Internet page is transmitted to the second client means C2 together with the second unique identifier ID2, and is displayed there for the second user U2.

The second user U2 now may inform the first user U1 about the second unique identifier ID2. The first user U1 may input the second unique identifier ID2 of the Internet page displayed at the first client means C1 notified to him into the input field 12, and may confirm the input with the button 13. By confirmation of the input, the Internet page assigned to the second unique identifier ID2 is requested by the first client means C1 by transmitting the second unique identifier ID2 to the server means S. For this, the server means S determines the Internet page assigned to the second unique identifier ID2 in the database DB, and transmits the determined Internet page (mask 2) to the first client means C1, where it is displayed for the first user U1.

Thereby, the Internet pages displayed at the first client means C1 and the second client means C2 are synchronized again.

As explained above with reference to FIG. 1, the exchange of unique identifiers ID1, ID2 between the two users U1, U2 may also be carried out within the system, i.e., two users U1, U2 do not have to input the corresponding unique identifiers manually. For this, it is only necessary for the first user U1 or customer to authenticate himself to the second user U2 or support assistant, for example, by notification of a login name or other identification uniquely identifying the first user U1. As soon as the support assistant U2 is notified about the identifier uniquely identifying the customer U1, the exchange of the unique identifiers ID1, ID2 may be executed within the system completely, as has been explained above with reference to FIG. 1, without the support assistant U2 having to inform the customer U1 (or the customer the support assistant) about the identifier by telephone.

FIG. 2b shows an alternative block diagram of a system according to the invention for explaining the method for synchronization of program masks according to the invention in an off-line mode.

A first client means C1 being assigned to a first user U1 is coupled to a server means S1 via a communications network. The server means S1 is, in turn, coupled to a database DB1. The server means S1 may also be part of the client means C1, wherein the client means C1 may be coupled to the database DB1. In a further embodiment, the database DB1 may also be part of the client means C1 such that the client means C1 comprises the server means S1 as well as also the database DB1. The server means, as part of the first client means C1, may also be configured as service being executable on the first client means C1.

The first server means S1 may comprise an application server or an Internet server.

The second client means C2 being assigned to a second user U2 is coupled to a second server means S2 via a communications network, which in turn may be coupled to a second database DB2. The server means S2 may also be part of the client means C2, wherein the client means C2 may comprise the second server means S2 and/or the second database DB2. The server means, as part of the second client means C2, may also be configured as a service being executable on the second client means C2.

However, in the off-line mode, the server means S1, S2 and/or the databases DB1, DB2 are not coupled to each other via a communications network.

Several websites or several application programs may be hosted on the first server means S1 and on the second server means S2. For example, a product website and/or an operation system or another application program may be hosted on both server means S1, S2.

In the first database DB1 and in the second database DB2, a unique identifier is stored respectively for a certain application (website or application program) for each program mask of the application, wherein in the two databases DB1, DB2, the same unique identifier is stored for the same program mask and assigned to the program mask.

The first user U1 requests via the first client means C1 a program mask from the first server means S1, which is displayed at the first client means C1. Prior to displaying the requested program mask at the first client means C1, the server means S1 determines the unique identifier assigned to the requested program mask in the first database DB1. The requested program mask is then transmitted together with the unique identifier (first unique identifier ID1) to the first client means C1, and is displayed there together with the requested program mask.

The first unique identifier ID1 determined and displayed at the first client means C1 is then transmitted to the second client means C2 being effected, for example, by the first user U1 informing the second user U2 about the first unique identifier ID1, as far as no communication connection exists between the first client means C1 and the second client means C2. As far as a communication connection exists between the two client means C1, C2, the first unique identifier ID1 can be transmitted via this communication connection from the first client means C1 to the second client means C2.

After transmission of the first unique identifier ID1, the second user U2 may input the latter into a support input field at the second client means C1, and request the program mask from the second server means S2 belonging to this unique identifier ID1. For this, the first unique identifier ID1 is transmitted from the second client means C2 to the server means S2, which queries the program mask belonging to this unique identifier by means of the first unique identifier ID1 from the database DB2. The determined program mask is then transmitted from the server means S2 to the second client means C2 and is displayed there.

The program masks displayed at the first client means C1 and at the second client means C2 now are synchronous, i.e., the same program mask is displayed for the users U1 and U2. As a result, the first user U1 and the second user U2 are able to communicate via the displayed program masks.

The second user U2, who may be, for example, a support assistant, now has the possibility to “guide” the first user, for example, a customer, to another program mask. For this, the second user U2 requests via the second server means C2, an alternative program mask from the second server means S2. For the requested alternative or a second program mask, the server means S2 determines a second unique identifier ID2 and transmits the latter together with the requested second program mask to the second client means C2, where it is displayed together with the requested program mask.

The second user U2 may now inform the first user U1 about this second unique identifier ID2, as far as no communication connection exists between the first client means C1 and the second client means C2. In case a communication connection exists between the two client means C1, C2, the second unique identifier ID2 may be transmitted from the second client means C2 to the first client means C1. Upon receipt of the second unique identifier ID2 by the first client means C1, the first client means C1 may request the program mask belonging to this second unique identifier ID2 from the first server means S1. The requested alternative or second program mask is then displayed at the first client means C1.

Thereby, the Internet pages displayed at the first client means C1 and the second client means C2 are synchronized again.

The method described in connection with FIG. 2b may also be used for synchronization of program masks, which, for example, belong to the operation system of the first or the second client means C1, C2.

The first client means C1 and the second client means C2 may be coupled to each other via a communications network, as the Internet, (wherein no connection via the communications network is provided between the two server means S1 and S2, which may be the case, for example, if company internal servers are concerned with respect to the two server means S1 and S2, which do not have access to an external communications network, for example the Internet). In case both client means C1 and C2 may be coupled via a communications network, the exchange of the first unique identifier ID1 and the second unique identifier ID2 may be executed via the communications network. In this case, the two client means C1 and C2 are adapted to transmit unique identifiers to the respective other one of the client means or to receive unique identifiers from the respective other client means. Preferably, then the two client means C1 and C2 are further adapted to induce a request to the respective server means as reaction to a received unique identifier in order to request the program mask assigned to the received unique identifier from the respective server means.

According to a preferred embodiment of the invention according to the configuration shown in FIG. 2b, it may be provided for the databases DB1 and DB2 to be synchronized cyclically or as needed, in order to ensure that in the two databases, the same program masks also are assigned to the same unique identifiers. By means of the synchronization it may also be ensured that, for example, program masks newly added to the database DB2 or their unique identifiers are also added to the database DB1. In case, for example, program masks and the unique identifiers of a certain version of an application program belonging thereto are stored in the databases DB1 and DB2, it may be ensured that after an update of the application program on the second server means S2, the unique identifiers of the program masks of the new version are also available in the database DB1. This is also applicable for an update of an operation system to a new version, wherein here, also an update of the unique identifiers or the assignments of the unique identifiers to the program masks of the operation system is carried out.

FIG. 3 shows a sequence diagram of a method according to the invention, according to which a program mask being displayed at the second client means C2, for example, an Internet page, is synchronized with the program mask displayed at the first client means C1, for example, an Internet page, and for which the modifications of the Internet page carried out at the second client means C2 are synchronized with the first client means C1.

In a first step S1, a first request message is transmitted from the first client means C1 to the server means S, by means of which a first program mask is requested from the server means S. The server means S analyzes the received first request message, and generates, in a second step S2 a unique identifier ID1, which is stored in the database DB in a step S3.

The first unique identifier ID1 is assigned to the requested first program mask in the database DB. The unique identifier ID1 is generated once again for each requested program mask, wherein different identifiers are generated for one and the same program mask which is requested by different first client means C1, and are stored in the database DB. Thereby, it is ensured that modifications, which are made for a program mask, are only transmitted to a first client means respectively in the steps S10 to S12 such that the modifications respectively only will be effective at one first client means, even if the program mask is being displayed at different first client means.

After the first unique identifier ID1 has been stored in the database DB and has been assigned to the requested mask, the requested program mask and the first unique identifier ID1 are transmitted to the first client means C1 in the step S4, and are being displayed there. The first unique identifier ID1 may be displayed at the first client means C1 in the display field 11, as has been described with respect to FIG. 1.

In the subsequent step S5, the unique identifier ID1 is notified to the second client means C2. In the step S6, a second request message is then transmitted from the second client means C2 to the server means S, wherein the second request message comprises at least the first unique identifier ID1 received in the step S5. After receiving the second request message, the server means S determines the program mask assigned to the received first unique identifier ID1 in the steps S7 and S8, by requesting the program mask assigned to the first unique identifier ID1 in the database DB. The program mask thus determined is transmitted to the second client means C2 in the step S9 and is displayed there. The first unique identifier ID1 may also be displayed in a display field 11 at the second client means C2.

After completion of the step S9, the same program mask is displayed at the first client means C1 and at the second client means C2 such that the program masks displayed at the two client means are synchronized. The users U1, U2 of the first client means C1 or the second client means C2 may now communicate via the displayed program mask, which may be effected, for example, via a telecommunications link between the two users. The communication may, however, also result from direct messages between the first user and the second user, wherein the direct messages may be displayed or input in a further program mask which is independent of the requested program mask.

According to the invention, the user U2, who may be, for example, a support assistant, may modify the first program mask displayed at the second client means C2, wherein the program mask displayed at the first client means C1 is being synchronized with the program mask displayed at the second client means C2.

For this, the user U2 at the second client means C2 makes modifications to the program mask which is displayed. For example, the second user U2 may mark important product information for the product displayed in the program mask, may replace available texts by new texts, may replace the displayed product price by a new price, or the like.

The modifications to the program mask made by the user U2 are transmitted to the server means S by means of an update message in step S10. The server means S provides the modifications made to the program mask for transmission to the first client means C1.

According to a preferred embodiment of the method according to the invention, the modifications received with the update message are stored in the database DB, and are assigned to the first unique identifier ID1 there. By the assignment of the modifications to the first unique identifier ID1, it is ensured that the modifications only concern that program mask, which is displayed at the first client means C1, even if the same program mask is also displayed at the other first client means.

In a further step S11, the modifications are transmitted from the server means S to the first client means C1. For this, the first client means C1 or the program mask being displayed at the first client means C1 may be configured to cyclically query the server means as to whether modifications are available for the program mask (which is identified by the first unique identifier ID1) displayed at the first client means C1. In response to such a request, the modifications are transmitted from the server means S to the first client means C1, or the first client means C1 is informed that no modifications are available.

After the modifications have been transmitted to the first client means C1 in the step S11, in the step S12, the program mask displayed at the first client means C1 is updated with the modifications such that after the update of the program mask, the program mask displayed at the first client means C1 is synchronized to the program mask displayed at the second client means C2. If, for example, the product price is replaced by a new price in the program mask displayed at the second client means C2, then, after execution of the steps S11 and S12, the new price is also displayed in the program mask displayed at the first client means C1.

The steps S10 to S12 may be carried out several times, i.e., the program mask displayed at the second client means C2 may be modified several times, wherein each one of the modifications made, effects an update of the program mask displayed at the first client means C1.

In a last step S13, the first unique identifier ID1 stored in the database DB is deleted, wherein also the mask assigned to the first unique identifier ID1 or the modifications assigned to the first unique identifier ID1 are deleted. Thereby, the method shown in FIG. 3 is terminated.

FIG. 4 shows a sequence diagram of a method according to the invention, according to which the user U2 of the second client means C2 may instruct the first client means C1 to display a new program mask, and, in fact, that one, which is being displayed at the second client means C2.

The method shown in FIG. 4 may be used as continuation of the method shown in FIG. 3.

In a first step S1.1, a third request message is transmitted from the second client means C2 to the server means S, by means of which a second program mask is requested from the server means S.

The server means S receives the third request message, and, in a step S2.1, generates a second unique identifier ID2, which is stored in the database DB in a further step S3.1, and is assigned to the requested second program mask there.

In the step S4.1, the requested second mask is transmitted to the second client means C2 together with the second unique identifier ID2, and is displayed there, wherein the second unique identifier ID2 may be displayed in the display field 11, as shown with reference to FIG. 1.

In the next step S5.1, the second unique identifier ID2 is notified to the first client means C1 by the second client means C2.

Alternatively, the second unique identifier ID2 may be requested by the server means S through the first client means C1, and may be transmitted to the first client means C1 from the server means S. In this case, the second unique identifier ID2 is made available by the server means S for transmission to the first client means C1. The first client means C1 may query the server means S cyclically, whether a new unique identifier, i.e., the unique identifier ID2, is available for transmission.

As soon as the second unique identifier ID2 is available at the first client means C1, a fourth request message is transmitted from the first client means C1 to the server means S, comprising at least the second unique identifier ID2. After receiving the fourth request message through the server means S, the server means determines, in the steps S7.1 and S8.1, the second program mask assigned to the second unique identifier ID2 in the database DB. The program mask thus determined is then transmitted from the server means S to the first client means C1 in the step S9.1 and is displayed there. Thereby, the program mask displayed at the first client means C1 is synchronous to the program mask displayed at the second client means C2.

In the subsequent steps S10 to S12, the program mask displayed at the second client means C2 may be modified, wherein the program mask displayed at the first client means C1 is synchronized with the modifications.

Hereby, the steps S10 to S12 correspond to the steps S10 to S12 in FIG. 3 so that a repeated description of these steps is omitted.

In a last step of the method according to FIG. 4, the second unique identifier ID2 stored in the database DB is deleted, whereby also the program mask assigned to the second unique identifier ID2 or the assigned modifications are deleted.

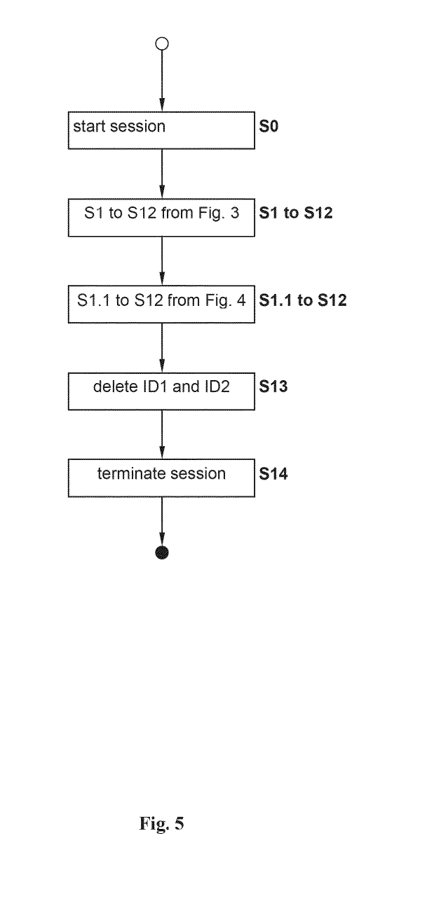

FIG. 5 shows a flow chart of the method according to the invention, according to which the method according to FIG. 3 and FIG. 4 are executed consecutively.

In a first step S0, here, a session is started for the first client means C1, which may be initiated, for example, by requesting a program mask by the first client means. During session set up, also an authentication of the first user U1 may be executed with respect to the server means S. Preferably, the session is identified by a unique session identifier. The session identifier may be a session ID or the log in of the first user. The session identifier is used to uniquely identify the first user at the first client means C1, or to distinguish the first user U1 at the first client means from other users at other first client means.

As far as no session has been started, for example, also the MAC address, a browser identifier (as far as the program mask to be synchronized is an Internet page), a software license number, a hardware serial number, an EAN code, or a unique biometric feature may be used as distinguishing feature for different users at different first client means. As unique distinguishing feature, also a telephone number, if needed, with area code, may be provided.

After the session has been started, the steps S1 to S12 of the method shown in FIG. 3 are executed, by means of which the program mask displayed at the second client means C2 is synchronized with the program mask displayed at a first client means C1.

Next, the steps S1.1 to S12 of the method according to FIG. 4 are executed, by means of which the program mask displayed at the first client means C1 is synchronized with the program mask displayed at the second client means C2.

For completion of the method, the first unique identifier ID1 and the second unique identifier ID2 are deleted in the database DB, and the session is terminated in the step S14. By means of the method according to the invention described above, it is now possible to synchronize program masks nearly in real time.

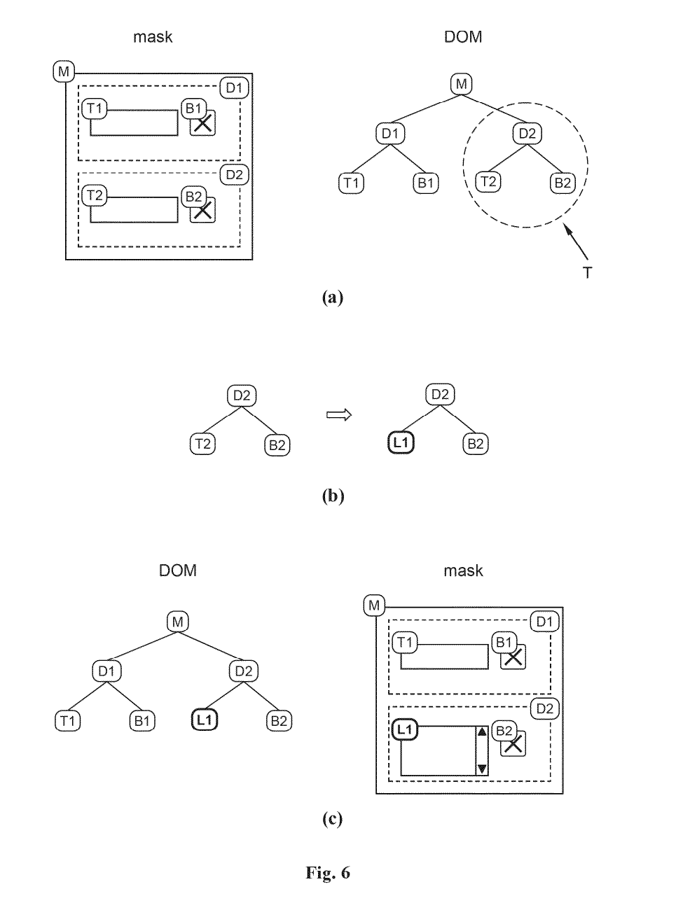

FIG. 6 shows by means of a program mask, which is an Internet page, how an update of an Internet page may be carried out according to the method steps S10 to S12 (cf. FIG. 3 and FIG. 4).

FIG. 6a shows a program mask, which is displayed at the first client means C1 and at the second client means C2, and a hierarchical tree structure representing the program mask.

The program mask consists of a high level element M, forming the root node of the hierarchical tree structure. The mask or the element M comprises two areas D1, D2 (for example, so-called HTML-DIV's), which respectively form a child node of the root node M in the hierarchical tree structure. Each one of the two areas D1, D2 here, comprises an input field T1 or T2 and a checkbox B1 or B2. The input field T1 and the checkbox B1 form child nodes of the element T1 in the hierarchical tree structure. The input field T2 and the checkbox B2 form child nodes of the element T2 in the hierarchical tree structure.

According to the example shown in FIG. 6, now, the input field T2 is to be replaced by a list box L1. The user U2 at the second client means C2, hereby, may remove the input field T2 and may insert a new list box L1 into the area D2. The part T of the hierarchical tree structure affected by the modification is shown in FIG. 6b, wherein here, it can be seen that the node T2 is replaced by the node L1, i.e., the node L1 is inserted into the hierarchical tree structure as child of the node T2.

The new hierarchical tree structure resulting from this is shown in FIG. 6c. In order to synchronize the program mask displayed at the first client means with the modifications carried out at the second client means C2, the modified part T, which now comprises the list box L1 as child node of the element D2, is transmitted by means of an update message from the second client means C2 to the server means S, and is assigned to the unique identifier of the program mask there.

The first client means C1 may now query the server means, whether a modification of this program mask is available. If this is the case, the part T of the hierarchical tree structure, which now comprises the list box L1 as child node of the element D2, is transmitted from the server means to the first client means C1. After the part T of the hierarchical tree structure has been transmitted to the first client means C1, the first client means may update the hierarchical tree structure, which represents the program mask displayed at the first client means C1, by removing, for example, the node D2 together with its child elements from the hierarchical tree structure, and by inserting the modified part T as child node of the element M into the hierarchical tree structure. The result then is the hierarchical tree structure shown in FIG. 6c.

The modification of the hierarchical tree structure at the first client means C1 causes the program mask being displayed there to be modified too, and displaying a list box L1 instead of the input field T2. Thereby, the program mask displayed at the first client means C1 is synchronized with the program mask displayed at the second client means C2.

Referring to FIG. 6, an updating of a program mask has been shown using as an example an Internet page, which is represented by a so-called document object model (DOM). According to the invention, also other representations of an Internet page may be used. In particular, by means of the method described above, also input masks of a computer program can be modified and the modifications can be synchronized.

### REFERENCE NUMERALS

10 program mask (e.g., Internet page)
11 display field for unique identifier of the program mask
12 input field for input of a unique identifier of a program mask
13 button for confirmation of the input into the input field 12
S0-S14 method steps
C1 first client means
C2 second client means
DB, DB1, DB2 data base
ID1 first unique identifier
ID2 second unique identifier
S, S1, S2 server means (e.g., web server)
T the part(s) of the program mask to be updated
U1 first user (e.g., customer)
U2 second user (e.g., support assistant)

What is claimed is:

1. A method for synchronization of program masks in a system, the system comprising at least one server means (S) and at least a first client means (C1) and a second client means (C2), wherein the client means (C1; C2) can be coupled to the at least one server means (S), and wherein the method comprises:
receiving (S1) a first request message from the first client means (C1), wherein a first program mask (10) is requested by the first request message;
determining a first unique identifier (ID1) for the requested first program mask (10);
transmitting (S4) the requested first program mask (10) and the first unique identifier (ID1) to the first client means (C1);
receiving (S6) a second request message from the second client means (C2), wherein the second request message comprises at least the first unique identifier (ID1);
determining (S7; S8) the first program mask (10), which is assigned to the received first unique identifier (ID1); and
transmitting (S9) the determined first program mask (10) to the second client means (C2).

2. The method of claim 1, wherein the determining of the first unique identifier (ID1) comprises:
generating (S2) the first unique identifier (ID1) for the requested first program mask (10); and
storing (S3) the first unique identifier (ID1) in a storage means (DB), wherein the first unique identifier (ID1) is assigned to the requested first program mask (10).

3. The method of claim 1, wherein during determining (S7; S8) of the first program mask (10), the first program mask (10) assigned to the received first unique identifier (ID1) is queried (S7) in the storage means (DB), and information on the first program mask (10) is received (S8) by the storage means (DB) as a result of the query.

4. The method of claim 1, wherein the first unique identifier (ID1) received with the second request message by the second client means (C2) has been transmitted (S5) from the first client means (C1) to the second client means (C2).

5. A method for synchronization of program masks in a system, the system comprising at least one server means (S) and at least a first client means (C1) and a second client means (C2), wherein the client means (C1; C2) can be coupled to the at least one server means (S), and wherein the method comprises:
receiving (S1.1) a search request message from the second client means (C2), wherein a second program mask (10) is requested by the search request message;
determining a second unique identifier (ID2) for the requested second program mask (10);
transmitting (S4.1) the requested second program mask (10) and the second unique identifier (ID2) to the second client means (C2);
receiving (S6.1) a fourth request message from the first client means (C1), wherein the fourth request message comprises at least the second unique identifier (ID2);
determining (S7.1; S8.1) the second program mask (10), which is assigned to the received second unique identifier (ID2); and
transmitting (S9.1) the determined second program mask (10) to the first client means (C1).

6. The method of claim 5, wherein the determining of the second unique identifier (ID2) comprises:
generating (S2.1) the second unique identifier (ID2) for the requested second program mask (10); and
storing (S3.1) the second unique identifier (ID2) in a storage means (DB), wherein the second unique identifier (ID2) is assigned to the requested second program mask (10).

7. The method of claim 5, wherein during determining (S7.1; S8.1) of the second program mask (10), the second program mask (10) assigned to the received second unique identifier (ID2) and the storage means (DB) is queried (S7.1) in the storage means (DB), and information on the second program mask (10) is received (S8.1) by the storage means (DB) as result of the query.

8. The method of claim 5, wherein the second unique identifier (ID2) received by the first client means (C1) with the fourth request message has been transmitted (S5.1) from the second client means (C2) to the first client means (C1).

9. The method of claim 1, further comprising the steps of:
receiving (S1.1) a search request message from the second client means (C2), wherein a second program mask (10) is requested by the search request message;
determining a second unique identifier (ID2) for the requested second program mask (10);
transmitting (S4.1) the requested second program mask (10) and the second unique identifier (ID2) to the second client means (C2);
receiving (S6.1) a fourth request message from the first client means (C1), wherein the fourth request message comprises at least the second unique identifier (ID2);
determining (S7.1; S8.1) the second program mask (10), which is assigned to the received second unique identifier (ID2); and
transmitting (S9.1) the determined second program mask (10) to the first client means (C1).

10. The method of claim 1, wherein the steps are carried out on the server side.

11. The method of claim 1, wherein the server means (S) receives (S10) an update message from the second client means (C2), which comprises information on which parts (T) of the first and second program masks (10) comprising a number of parts transmitted (S4; S9) to the first client means (C1) are to be updated and how they are to be updated.

12. The method of claim 11, wherein the server means stores the received update message in the storage means (DB) and assigns it to the first or second unique identifier (ID1; ID2).

13. The method of claim 11, wherein the server means (S) provides the update message for transmission (S11) to the first client means (C1) in order to effect an update (S12) of the transmitted (S4; S9) first or second program masks (10) according to the information comprised in the update message at the first client means (C1).

14. The method of claim 1, wherein the server means (S), during termination of the method, effects (S13) a deletion of the first or second unique identifiers (ID1; ID2) in the storage means (DB).

15. The method of claim 1, wherein in a first step (S0), a session is started for the first client means (C1), and the session is terminated in a last step (S14).

16. The method of claim 1, wherein the first client means (C1) is identifiable by a unique client identifier, and wherein the first or the second unique identifier (ID1; ID2) is assigned to the client identifier, and the assignments are stored in the storage means.

17. The method of claim 16, wherein in a last step (S14), the session is terminated, and the unique identifiers (ID1; ID2) assigned to the client identifier are deleted in the storage means.

18. The method of claim 16, wherein the unique client identifier comprises one of an IP address, MAC address, browser identifier, software license number, hardware serial number, email address, telephone number, EAN code, and a unique biometric feature.

19. The method of claim 11, wherein the first or the second program masks (10) is represented by a hierarchical tree structure, wherein each part of the program mask is represented by a node in the tree structure, wherein each part of the program mask may comprise a number of parts of the program mask, and wherein the update message comprises information on which nodes of the tree structure are to be updated and how they are to be updated.

20. The method of claim 1, wherein the first or the second program masks (10) comprises a display field (11) for display of the first and the second unique identifiers (ID1; ID2) and an input field (12) for input of the first or the second unique identifiers (ID1; ID2).

21. The method of claim 1, wherein the program mask is an input mask of a computer program or an Internet page.

22. The method of claim 1, wherein the first and the second unique identifiers (ID1; ID2) respectively are a sequence of digits, and wherein the number of digits of the first identifier (ID1) is different from the number of digits of the second identifier (ID2).

23. The method of claim 22, wherein the second identifier (ID2) has fewer digits than the first identifier (ID1).

24. The method of claim 1, wherein the server means (S) is part of the first client means (C1) or is part of the second client means (C2), in particular, as a service being executable on the first client means (C1) and/or on the second client means (C2).
